(19) United States
(12) Patent Application Publication
(10) Pub. No.: US 2026/0300183 A1
(43) Pub. Date: Oct. 1, 2026

(54) CACHE REPLACEMENT METHOD AND SYSTEM

(71) Applicant: Advanced Micro Devices, Inc., Santa Clara, CA (US)

(72) Inventor: Seyed Mohideen Basheer Ahamed, Sydney (AU)

(21) Appl. No.: 19/095,839

(22) Filed: Mar. 31, 2025

(51) Int. Cl. G06F 12/0891

(52) U.S. Cl. CPC G06F 12/0891; G06F 2212/601

(57) ABSTRACT

An implementation is a method for cache replacement may include storing a previous access bit and a current access bit for each upper level of a binary tree representing cache blocks, accessing, by a processor, a data segment in memory, selecting, by a cache controller in response to a cache miss for the data segment, a cache block for replacement using the binary tree by traversing the binary tree using the previous access bit at a first upper level, and using the current access bit at a lowest level to determine the cache block for replacement.

### BACKGROUND

Cache memory plays a crucial role in modern computing systems by storing frequently accessed data closer to the processor, thereby reducing access times and improving overall system performance. As processor speeds continue to outpace memory speeds, effective cache management becomes increasingly integral to system operation. Cache replacement policies determine which data should be evicted from the cache when new data needs to be stored. These policies aim to maximize cache hit rates by predicting which data is likely to be accessed in the near future.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a block diagram of a computing system.

FIG. 2 illustrates a block diagram of a processor system with multiple cores and cache levels.

FIG. 3 illustrates a block diagram of a cache structure with set-associative organization.

FIG. 4 illustrates a binary tree for implementing a cache replacement algorithm.

FIG. 5A-5N illustrate various states of a binary tree for a History-based Pseudo Least Recently Used cache replacement algorithm.

FIG. 6 illustrates a block diagram of an expanded binary tree for an 8-way cache replacement implementation.

Corresponding numerals and symbols in the different figures generally refer to corresponding parts unless otherwise indicated. The figures are drawn to clearly illustrate the relevant aspects of the implementations and are not necessarily drawn to scale. The edges of features drawn in the figures do not necessarily indicate the termination of the extent of the feature.

### DETAILED DESCRIPTION OF ILLUSTRATIVE IMPLEMENTATIONS

The making and using of various implementations are discussed in detail below. It should be appreciated, however, that the various implementations described herein are applicable in a wide variety of specific contexts. The specific implementations discussed are merely illustrative of specific ways to make and use various implementations, and should not be construed in a limited scope.

Reference to “an implementation” or “one implementation” in the framework of the present description is intended to indicate that a particular configuration, structure, or characteristic described in relation to the implementation is included in at least one implementation. Hence, phrases such as “in one implementation” that may be present in one or more points of the present description do not necessarily refer to one and the same implementation. Moreover, particular conformations, structures, or characteristics may be combined in any adequate way in one or more implementations. The references used herein are provided merely for convenience and hence do not define the extent of protection or the scope of the implementations.

Cache replacement is a process in computer systems that manages the limited space within cache memory. As programs access more data than can fit in the cache, efficient replacement strategies become essential for maintaining system performance. The Least Recently Used (LRU) algorithm represents an accurate but hardware-intensive approach to cache replacement. For practical implementations, approximations such as the Pseudo Least Recently Used (PLRU) algorithm are often employed. These approximations trade some accuracy for hardware efficiency. However, in scenarios with complex access patterns, such as interleaved memory accesses or multi-threaded workloads, PLRU algorithms may not capture usage patterns effectively. The History-based Pseudo Least Recently Used (PLRU) algorithm offers an innovative approach to this challenge by incorporating historical access patterns to make more informed replacement decisions.

In computer systems, the gap between processor speed and memory access time continues to widen, making effective use of cache crucial for overall system performance. Other cache replacement methods, such as the Least Recently Used (LRU) algorithm, may not always provide optimal results in complex scenarios. The History-based PLRU algorithm addresses this issue by considering not just recent usage but also longer-term access patterns, potentially reducing cache misses and improving system responsiveness.

One advantage of the History-based PLRU algorithm is its ability to handle caches with up to 32 entries effectively. This makes the algorithm suitable for a wide range of cache sizes commonly found in modern computer systems. By optimizing replacement decisions for these cache sizes, the algorithm may help improve overall system performance across various hardware configurations.

The History-based PLRU algorithm may be particularly effective for processing blocks with interleaving across multiple programs while accessing caches. In scenarios where different programs or threads compete for cache space, the algorithm's consideration of historical access patterns may lead to more intelligent replacement decisions. This may result in improved cache utilization and reduced conflicts between different programs or threads.

Another area where the History-based PLRU algorithm may provide significant benefits is in image processing applications. Specifically, the algorithm may be advantageous for image processing blocks that use streaming applications where the same image block is accessed in an interleaved manner. By recognizing and adapting to these access patterns, the algorithm may help maintain frequently used image data in the cache, potentially reducing the need for repeated memory accesses and improving processing speed.

The History-based PLRU algorithm represents an advancement in cache replacement strategies by combining the simplicity of PLRU methods with the added insight of historical access information. This approach may lead to more accurate predictions about which cache lines are likely to be needed in the future, potentially enhancing overall cache performance and system efficiency.

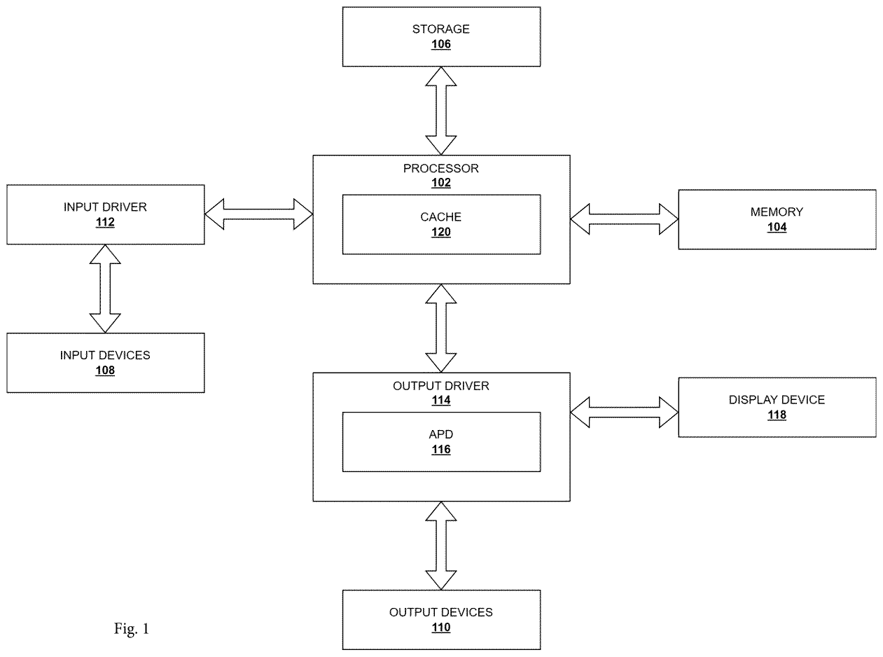

FIG. 1 illustrates a block diagram of a processing system according to various implementations. The processing system may include a device 100 comprising various components for data processing and management. The device 100 includes a processor 102, which functions as the central processing unit responsible for executing instructions and managing overall system operations. The processor 102 includes one or more processor cores, which can be either CPUs or GPUs, or a combination thereof located on the same die. The processor 102 may be directly linked to and interact with a cache 120 for swift data access. The memory 104 may be positioned on the same die as the processor 102 or located separately, depending on the specific implementation.

The device 100 may be embodied in various forms, such as a computer, gaming device, handheld device, set-top box, television, mobile phone, tablet computer, or other computing devices. In addition to the processor 102, the device 100 includes components such as memory 104, storage 106, input devices 108, output devices 110, input drivers 112, and output drivers 114. These drivers may be implemented as hardware, software, or a combination thereof, and are designed to control the operation of their respective devices, facilitating data transfer between the processor and the input/output components.

The cache 120 may be implemented as a small, fast memory that stores recently used data and instructions. In some cases, the cache 120 may be organized into multiple levels, such as a level 1 (L1) cache and a level 2 (L2) cache, to balance speed and capacity. The cache 120 may represent one or more cache memories of the processor 102, potentially organized into a cache hierarchy. The cache 120 helps reduce the average time to access data from main memory by keeping frequently accessed data closer to the processor 102.

The memory 104 may be implemented as random access memory (RAM) for storing data and instructions that are not immediately required by the processor 102. In some implementations, the memory 104 may be located on the same die as the processor 102, or may be located separately. The memory 104 may work in conjunction with the cache 120 to provide a hierarchical storage system, where frequently accessed data is stored in the faster cache 120 while less frequently accessed data remains in the slower but larger memory 104.

The storage 106 may be included in the computing system for long-term data retention. In some cases, the storage 106 may be a non-volatile storage device such as a hard disk drive, solid-state drive, optical disk, or flash drive. Data may be transferred between the storage 106, memory 104, and cache 120 as needed to support efficient processing operations.

The computing system may include input devices 108 and output devices 110 to facilitate user interaction. Input devices 108 may include keyboards, keypads, touchscreens, touch pads, detectors, microphones, accelerometers, gyroscopes, biometric scanners, or network connections. Output devices 110 may include displays, speakers, printers, haptic feedback devices, lights, antennas, or network connections.

The input driver 112 may manage communications between input devices 108 and the processor 102, while the output driver 114 may handle data transfer from the processor 102 to output devices 110. The input driver 112 and output driver 114 may include hardware, software, and/or firmware components configured to interface with and drive their respective devices.

The output driver 114 may include an accelerated processing device (APD) 116, which in some implementations may be coupled to a display device 118. The APD 116 may be configured to accept compute commands and graphics rendering commands from the processor 102, process those commands, and provide pixel output to the display device 118. In some implementations, the APD 116 may include one or more parallel processing units configured to perform computations in accordance with a single-instruction-multiple-data (SIMD) paradigm.

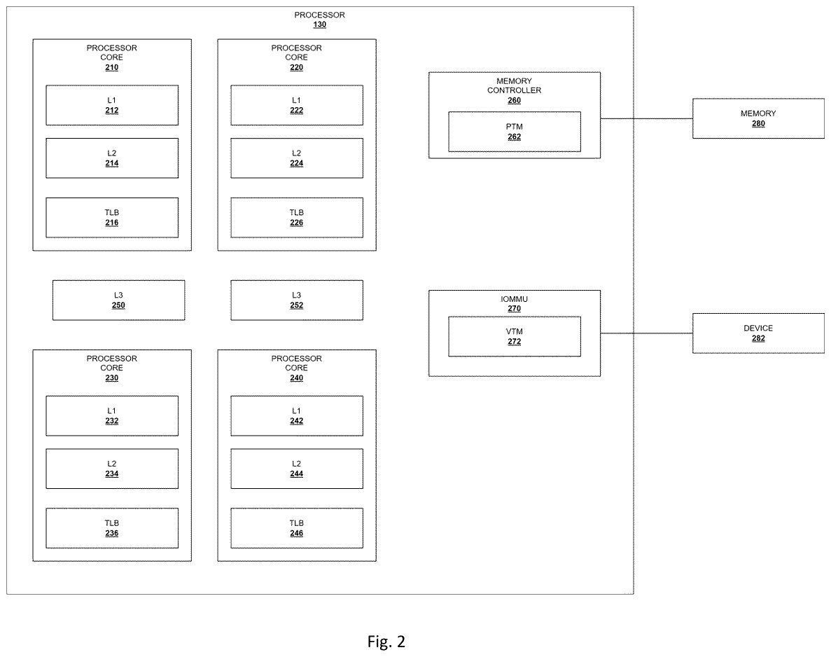

FIG. 2 illustrates a processor system 130 with multiple cores and cache levels according to various implementations.

The processor system 130 may include multiple processor cores arranged in a hierarchical structure with various levels of cache memory. In some cases, the processor system 130 may comprise four processor cores: a first processor core 210, a second processor core 220, a third processor core 230, and a fourth processor core 240. Each processor core has its own dedicated cache memories to enable fast access to frequently used data and instructions.

The first processor core 210 may be associated with a first level one cache 212 and a first level two cache 214. The first level one cache 212 may be a small, fast memory located closest to the first processor core 210, providing rapid access to the most frequently used data. The first level two cache 214 may be larger but slightly slower than the first level one cache 212, serving as an intermediate storage between the first level one cache 212 and larger, slower memory components.

Similarly, the second processor core 220 may be coupled with a second level one cache 222 and a second level two cache 224. The third processor core 230 may be connected to a third level one cache 232 and a third level two cache 234. The fourth processor core 240 may be linked to a fourth level one cache 242 and a fourth level two cache 244. This arrangement allows each processor core to have quick access to its own dedicated cache memories, potentially reducing data access times and improving overall processing efficiency.

In addition to the dedicated caches, the processor system 130 may include shared cache levels. A first level three cache 250 and a second level three cache 252 may be shared among multiple processor cores. These shared caches may be larger than the dedicated caches and may store data that may be accessed by any of the processor cores, facilitating data sharing and potentially reducing redundant data storage across individual core caches. For example, the first level three cache 250 may be shared between the first processor core 210 and the third processor core 230, while the second level three cache 252 may be shared between the second processor core 220 and the fourth processor core 240.

A memory controller 260 may be included in the processor system 130 to manage communication between the processor cores, caches, and a system memory 280. The memory controller 260 may include a page table module 262, which may assist in translating virtual memory addresses to physical memory addresses, enabling efficient memory management.

An input output memory unit 270 may be incorporated into the processor system 130 to handle data transfer between the processor cores and external devices. The input output memory unit 270 may include a virtual table module 272, which may help manage virtual memory operations related to input/output processes. The input output memory unit 270 may receive memory access requests from external devices and control their provision to the memory 280 or cache memories via the memory controller 260.

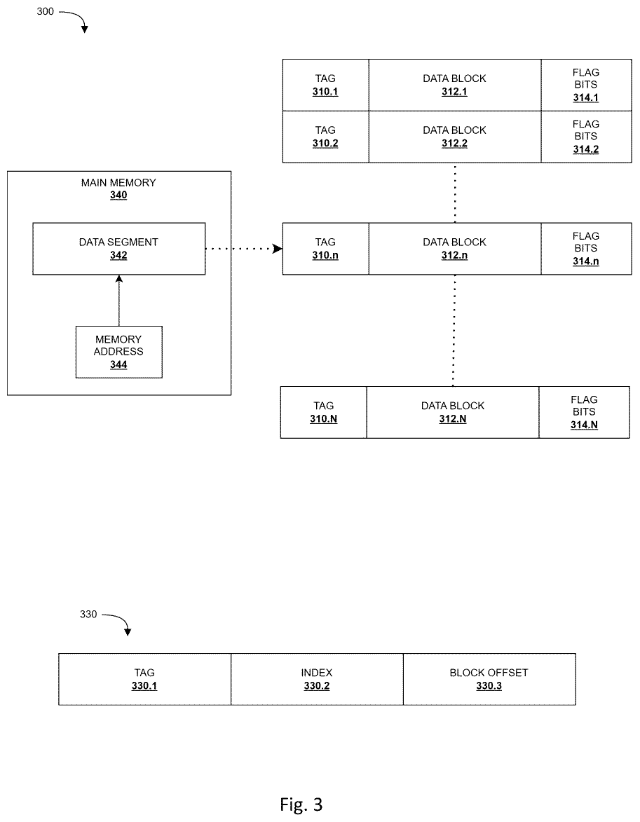

FIG. 3 illustrates a cache structure with set-associative organization according to various implementations.

A cache 300 may be organized into multiple sets, each containing several ways. In some cases, the cache 300 may be a 4-way set-associative cache, meaning each set contains four ways. The cache 300 may include multiple entries, each comprising a tag field, a data block, and flag bits.

A memory address 330 may be used to access data within the cache 300. The memory address 330 may be divided into three fields: a tag field 330.1, an index field 330.2, and an offset field 330.3. The bits that represent the memory address may be partitioned into these groups based on their bit significance. The index field 330.2 may be used to select a specific set within the cache 300.

Within each set, the cache 300 may store multiple entries. A first tag 310.1, a second tag 310.2, an intermediate tag 310.n, and a final tag 310.N may correspond to different ways within a set. Similarly, a first data block 312.1, a second data block 312.2, an intermediate data block 312.n, and a final data block 312.N may store the actual cached data for each way. Additionally, a first flag bits 314.1, a second flag bits 314.2, an intermediate flag bits 314.n, and a final flag bits 314.N may maintain status information for each cache entry.

When accessing data, the tag field 330.1 of the memory address 330 may be compared against the tags stored in each way of the selected set. If a match is found, the corresponding data block may be retrieved. The offset field 330.3 may then be used to select the specific data within the cache line.

A main memory 340 may work in conjunction with the cache 300. The main memory 340 may include a data segment 342 and an address register 344. When data is not found in the cache 300, it may be retrieved from the main memory 340 and stored in the cache 300 for future access.

The block offset 330.3, having the least significant bits of the address 330, provides an offset pointing to the location in the data block where the requested data segment is stored. For example, if a data block is a b-byte block, the block offset 330.3 will need to be log 2(b) bits long. The index 330.2 specifies the set of data blocks in the cache where a particular memory section can be stored. For example, if there are s number of sets, the index 330.2 will need to be log 2(s) bits long. The tag 330.1, having the most significant bits of the address 330, associates the particular memory section with the line in the set it is stored in.

The set-associative organization of the cache 300 allows for efficient data retrieval while balancing the trade-offs between fully associative and direct-mapped cache designs. By using multiple ways within each set, the cache 300 may reduce conflict misses and improve overall cache performance.

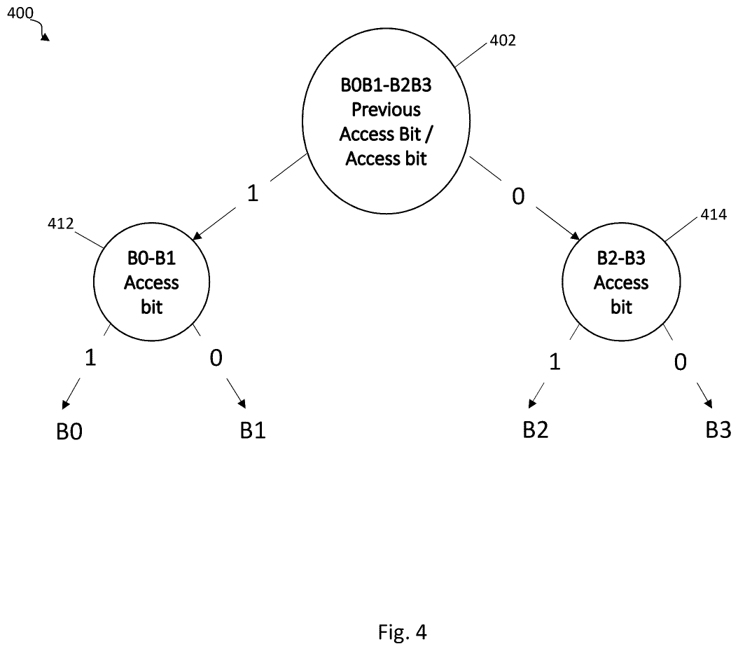

FIG. 4 illustrates a binary tree 400 for implementing a cache replacement algorithm according to various implementations.

The binary tree 400 may be used to represent the organization of cache blocks within a cache memory system. The binary tree 400 facilitates efficient tracking of access patterns and supports rapid decision-making for cache replacement processes.

The binary tree 400 includes multiple nodes arranged in a hierarchical structure. A B0B1-B2B3 previous and current access bits node 402 may be positioned at the root of the binary tree 400. The B0B1-B2B3 previous and current access bits node 402 maintains both previous and current access bit information for the represented cache blocks.

Branching from the B0B1-B2B3 previous and current access bits node 402, the binary tree 400 includes a B0-B1 access bit node 412 and a B2-B3 access bit node 414. The B0-B1 access bit node 412 represents access information for a first pair of cache blocks, while the B2-B3 access bit node 414 represents access information for a second pair of cache blocks.

Each non-leaf node of the binary tree 400 includes a previous access bit and a current access bit. The previous access bit stores historical access information, while the current access bit reflects the most recent access state. This dual-bit structure allows a cache controller to consider both recent and historical access patterns when making replacement decisions.

The binary tree 400 is structured such that the left branches are labeled with “1” and the right branches are labeled with “0”. This binary labeling is used to traverse the binary tree 400 when determining which cache block to replace during a cache miss.

The use of both previous and current access bits in non-leaf nodes of the binary tree 400 provides a comprehensive view of cache block usage over time. While traditional PLRU algorithms only consider the current access state, this additional historical information enables more informed replacement decisions, particularly in scenarios with interleaved memory access patterns.

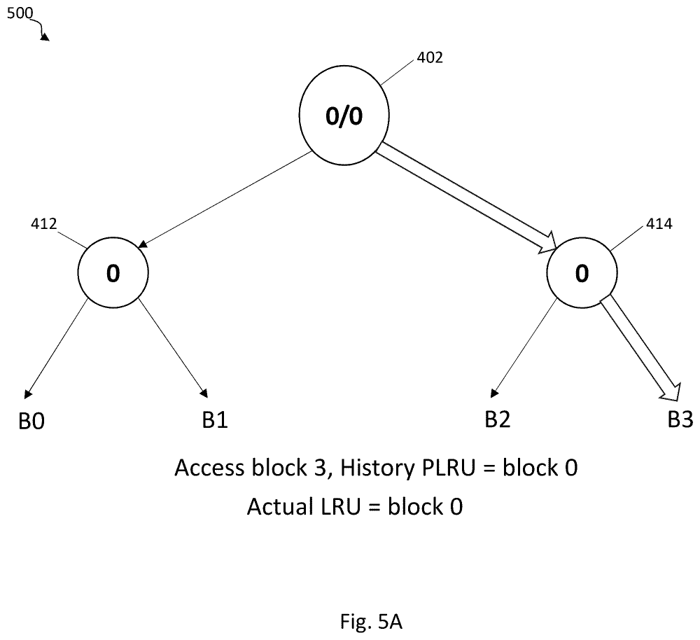

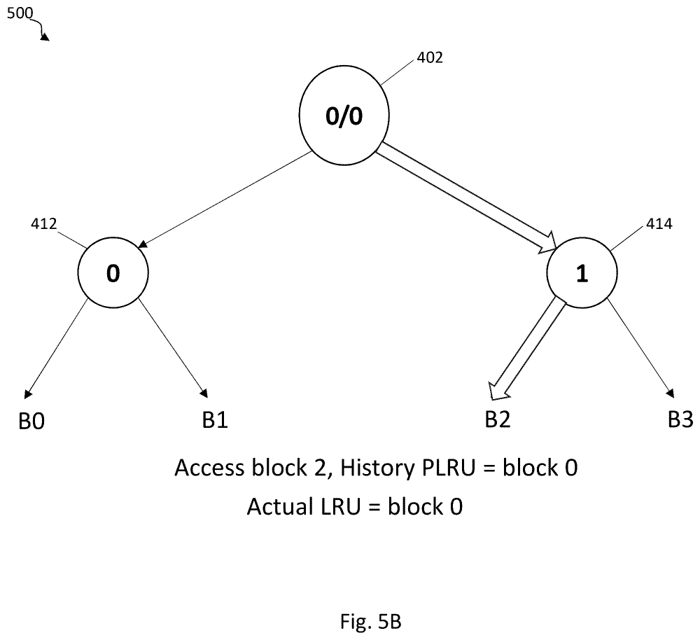

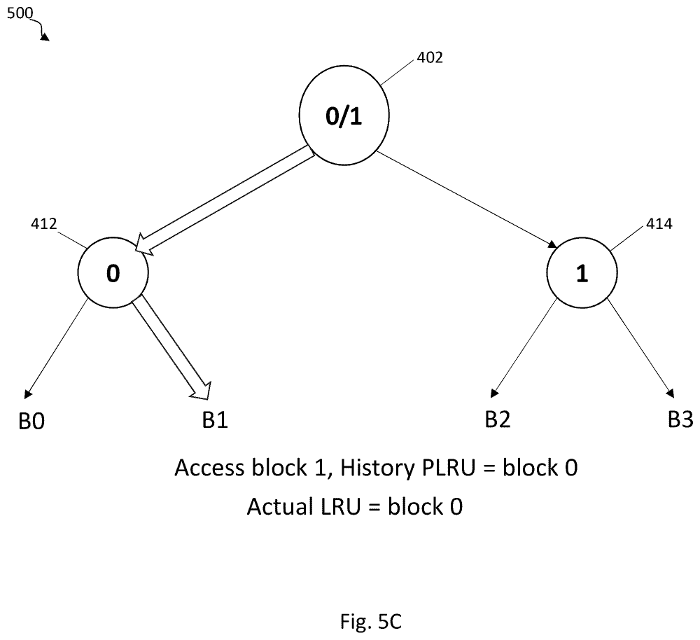

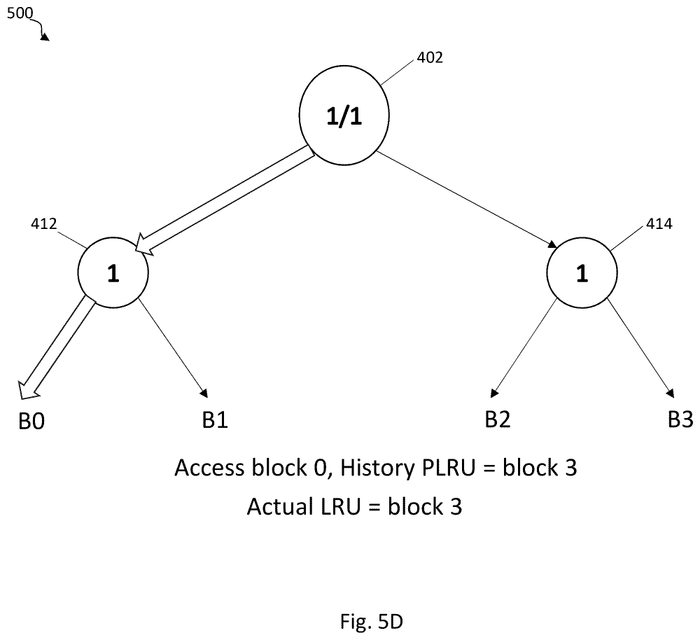

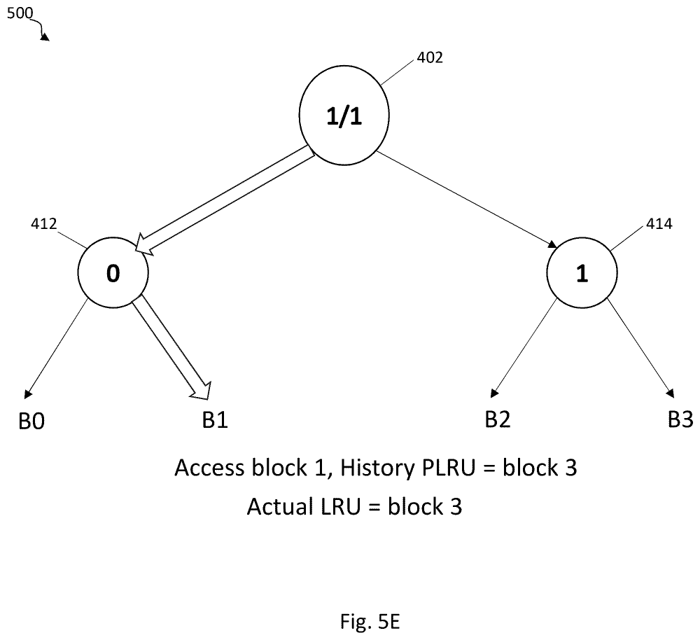

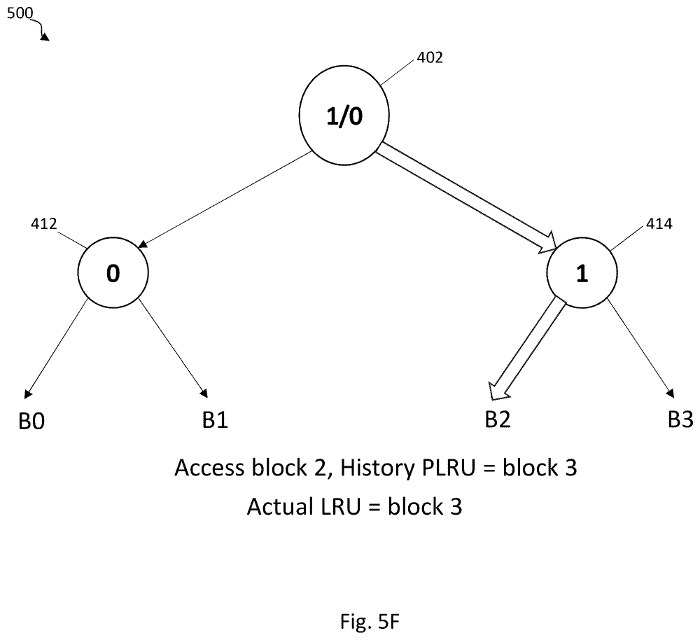

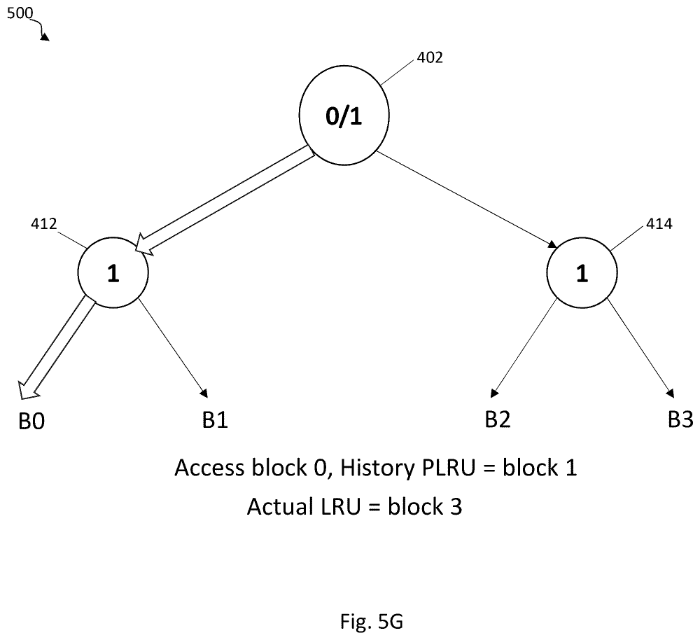

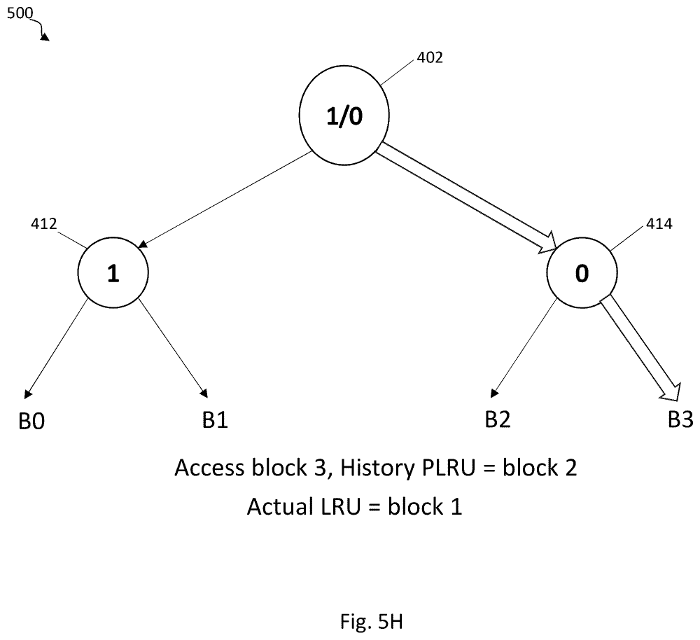

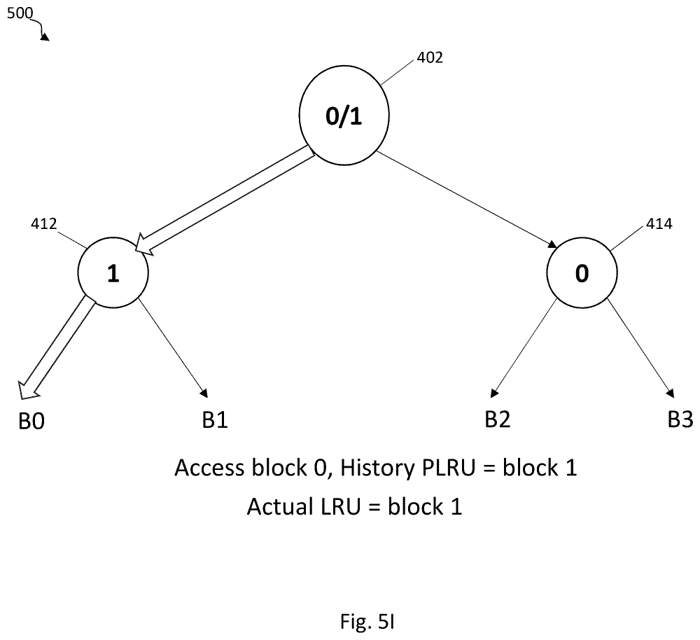

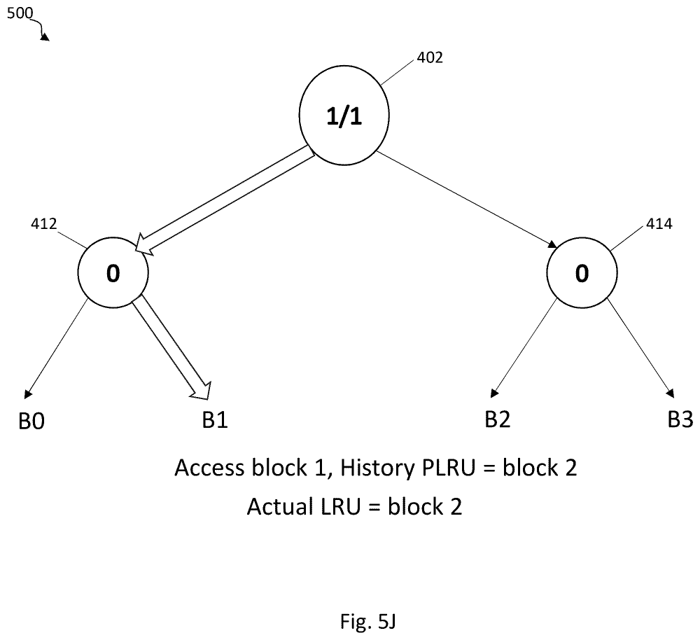

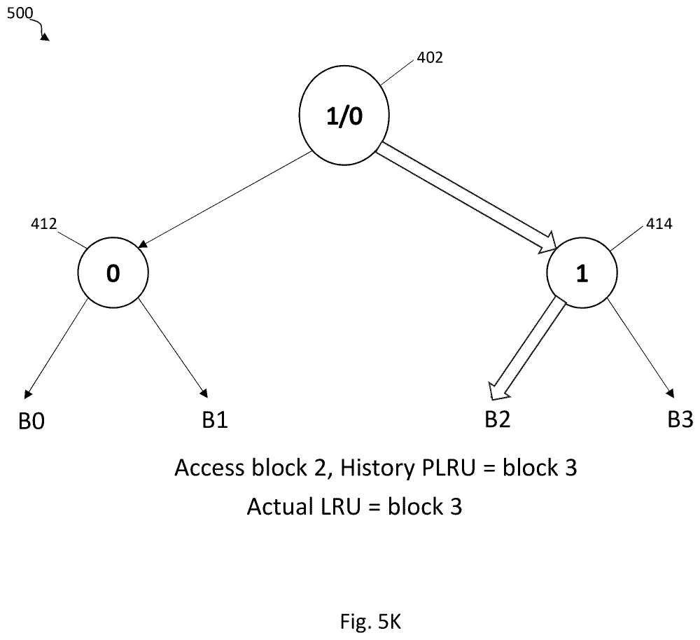

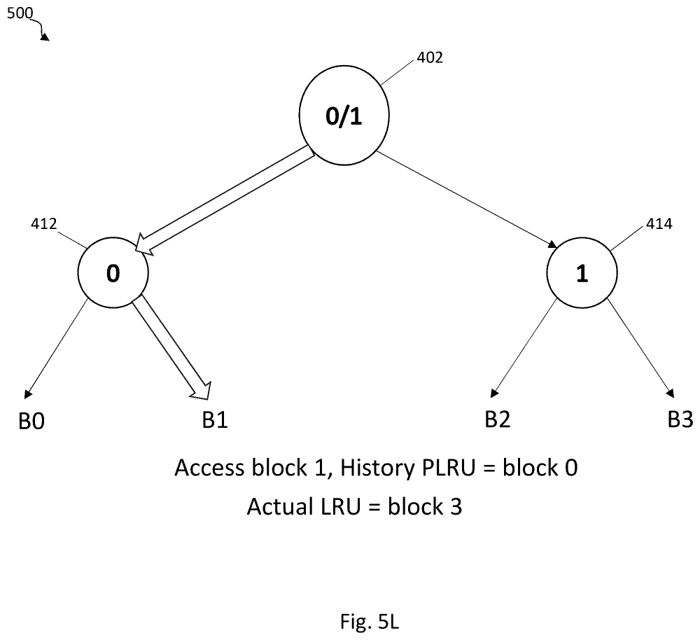

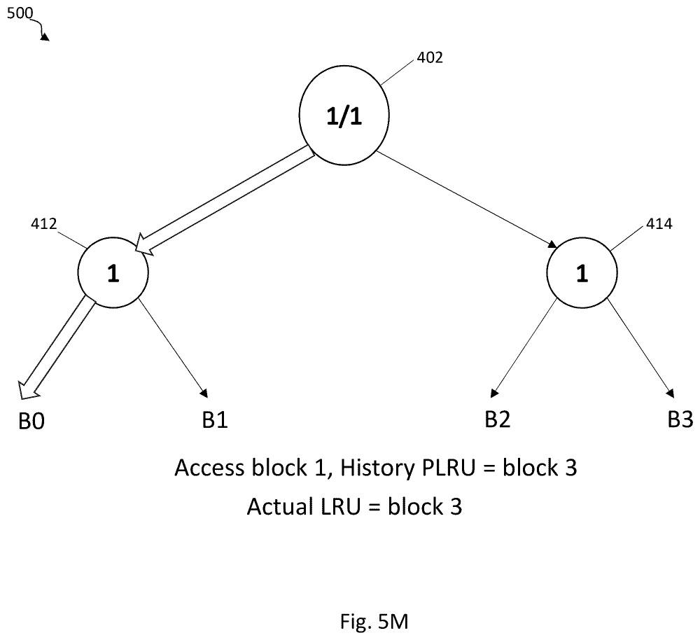

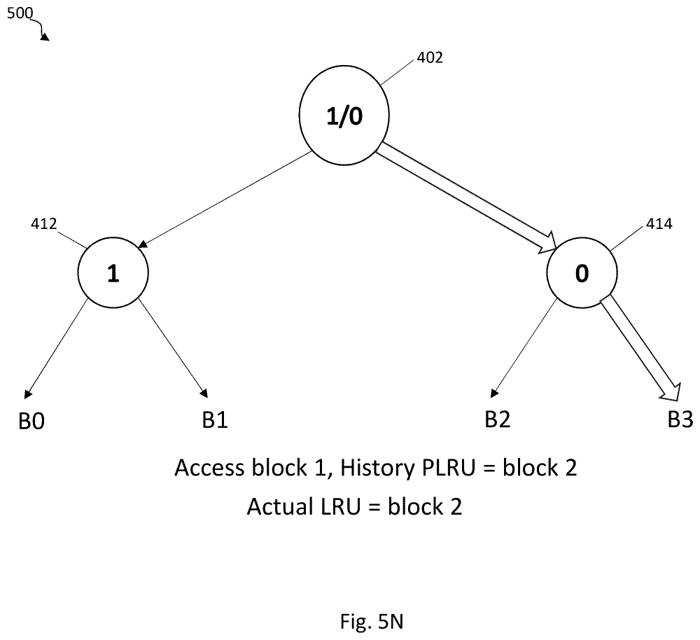

FIG. 5A-5N illustrate various states of the binary tree implementing the History-based Pseudo Least Recently Used (PLRU) cache replacement algorithm. These figures demonstrate how the algorithm updates and uses both current and previous access bits to track memory access patterns and make replacement decisions.

The access pattern of FIGS. 5A-5N will start with an empty binary tree and the initial accesses of B3, B2, B1 and B0 (e.g., FIGS. 5A-5D), and Table 1 below illustrates the access pattern after those initial set of accesses (e.g., FIGS. 5E-5N).

TABLE 1

| | | | | | | Least Recent |
|---|---|---|---|---|---|---|
| | | | | | | Entry |
| | | | | | | (selected |
| | | (PBOPB1)/ | (B0B1)/ | B0/ | B2/ | by History |
| | Accessed | (PB2PB3) | (B2B3) | B1 | B3 | based |
| Cycle | Block | Bit | Bit | Bit | Bit | PLRU) |
| 0 | B1 | 1 | 1 | 0 | 1 | B3 |
| 1 | B2 | 1 | 0 | 0 | 1 | B3 |
| 2 | B0 | 0 | 1 | 1 | 1 | B1 |
| 3 | B3 | 1 | 0 | 1 | 0 | B2 |
| 4 | B0 | 0 | 1 | 1 | 0 | B1 |
| 5 | B1 | 1 | 1 | 0 | 0 | B2 |
| 6 | B2 | 1 | 0 | 0 | 1 | B3 |
| 7 | B1 | 0 | 1 | 0 | 1 | B0 |
| 8 | B0 | 1 | 1 | 1 | 1 | B3 |
| 9 | B3 | 1 | 0 | 1 | 0 | B2 |

FIG. 5A illustrates a binary tree 500 implementing the History-based Pseudo Least Recently Used (PLRU) cache replacement algorithm in its initial state. The binary tree 500 represents a 4-way set associative cache with blocks B0-B3. The access bits at all of the nodes are all “0” in this initial state as the binary tree 500 as the related memory is empty. The root node 402 contains “0/0” indicating both previous and current access bits are 0. The child nodes 412 and 414 contain “0” for both B0-B1 and B2-B3 branches respectively. When accessing block 3, the History PLRU algorithm determines block 0 is the least recently used (also referred to as the replacement candidate) based on traversing this initial state.

FIG. 5B shows the binary tree 500 state after accessing block 2. The root node 402 maintains “0/0”, while node 412 remains “0” and node 414 updates to “1” to reflect the access to block 2. The algorithm identifies block 0 as the replacement candidate in this state.

FIG. 5C depicts the tree state when accessing block 1. The root node 402 updates to “0/1”, indicating the previous state “0” and current access to the B0-B1 branch. Node 412 maintains “0” while node 414 remains “1”. In this configuration, block 0 is identified as the replacement candidate.

FIG. 5D shows the state during access to block 0. The root node 402 contains “1/1”, reflecting both previous and current access to B0-B1. Both nodes 412 and 414 contain “1”. The algorithm determines block 3 is the replacement candidate.

FIG. 5E illustrates the state when accessing block 1. Root node 402 maintains “1/1”, node 412 updates to “0” indicating B1 access, and node 414 remains “1”. Block 3 is identified as the replacement candidate.

FIG. 5F shows the tree state for block 2 access. Root node 402 updates to “1/0”, reflecting the transition from B0-B1 to B2-B3 region. Node 412 contains “0” and node 414 contains “1”. The algorithm selects block 3 for replacement. This state demonstrates the algorithm's advantage when access patterns alternate—while traditional PLRU would only consider the current access to the B2-B3 region, the history-based approach maintains awareness of the recent B0-B1 accesses through the previous access bit.

FIG. 5G depicts the state for block 0 access. Root node 402 now shows “0/1”, capturing the previous B2-B3 access and current B0-B1 access. This alternating pattern between regions is one scenario where the history-based approach demonstrates improvement—the previous access bit “0” helps retain the context that B2-B3 was recently accessed, even as the access switches back to B0-B1. Nodes 412 and 414 update accordingly, leading to block 1 being selected as the replacement candidate. While this selection differs from the actual LRU in this specific instance, the algorithm's ability to consider historical context becomes beneficial across the overall access pattern sequence.

FIG. 5H shows the state during block 3 access. Root node 402 contains “1/0”, with nodes 412 and 414 updated to reflect the B2-B3 region access. The algorithm identifies block 2 as the replacement candidate. This transition between cache regions (from B0-B1 to B2-B3) demonstrates how the History-based PLRU makes different replacement decisions than traditional PLRU by considering previous access patterns. This approach is particularly beneficial in scenarios with regular alternating access patterns, though individual selections may vary from the actual LRU in specific instances.

FIG. 5I illustrates the state for block 0 access. Root node 402 shows “0/1”, capturing another region transition. The tree structure maintains access history to help select block 1 as the replacement candidate.

FIG. 5J depicts the tree state for block 1 access. The root node 402 maintains “1/1” to reflect continued B0-B1 region access. The configuration leads to block 2 being selected for replacement.

FIG. 5K shows the state during block 2 access. Root node 402 updates to “1/0” to capture the region transition. The history-based selection identifies block 3 as the replacement candidate.

FIG. 5L illustrates the state for block 1 access. The root node 402 shows “0/1”, with the previous bit helping maintain access pattern history during another region transition. While the algorithm selects block 0 as the replacement candidate in this specific instance, the overall approach of maintaining historical access information helps the algorithm adapt to varied access patterns. This ability to track both current and previous access states provides a different perspective on replacement decisions compared to traditional PLRU, which is particularly valuable across longer, complex access sequences.

FIG. 5M depicts the tree state for block 0 access. Root node 402 contains “1/1”, with both bits now reflecting B0-B1 region access. Block 3 is identified as the replacement candidate.

FIG. 5N shows the final state with block 3 access. Root node 402 updates to “1/0”, demonstrating how the algorithm maintains accuracy through varied access patterns by leveraging both current and historical access information.

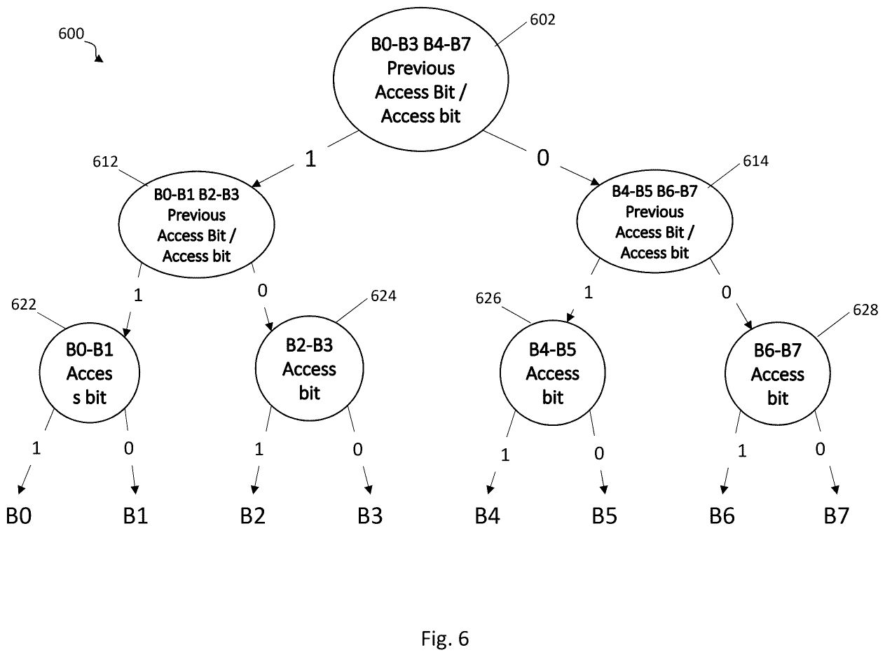

FIG. 6 illustrates a binary tree 600 implementing an expanded 8-way cache replacement algorithm. The binary tree 600 comprises multiple levels corresponding to different cache associativities, demonstrating how the history-based PLRU algorithm scales to larger cache configurations.

The root node 602 maintains both previous and current access bit information for blocks B0-B7. The root node connects to two first-level nodes-a left first level node 612 and a right first level node 614. Each first-level node tracks previous and current access bits for their respective blocks (B0B1-B2B3 and B4B5-B6B7).

At the leaf level, the binary tree 600 includes four leaf nodes: a first leaf node 622, a second leaf node 624, a third leaf node 626, and a fourth leaf node 628. These leaf nodes track access bits for blocks B0-B1, B2-B3, B4-B5, and B6-B7 respectively.

For example, when accessing Block B5, only the nodes along the path to B5 are updated: {previous and current access bits at node 602, previous and current access bits at node 614, and access bit at node 626}, while other bits retain their existing values. This selective update approach maintains historical information while reducing update overhead.

The 8-way implementation demonstrates how the algorithm scales to larger cache sizes while maintaining its benefits for interleaved access patterns. The binary tree structure efficiently represents the relationships between cache blocks and facilitates quick traversal for replacement decisions.

The history-based PLRU algorithm maintains its efficiency when scaling to larger cache configurations by preserving the binary tree structure while adding levels as needed. For 16-way set associative caches, an additional level would be added to the tree structure, resulting in a tree with five levels: the root node, three intermediate levels, and 16 leaf nodes representing individual cache blocks.

When traversing the tree in larger configurations, the algorithm continues to use the previous access bits at non-leaf levels for making replacement decisions. This approach is particularly effective in scenarios with varied access patterns. When multiple programs or threads share the cache, memory accesses often exhibit interleaving patterns across different cache regions. The history-based approach handles these patterns more effectively than traditional PLRU by maintaining previous access information at each tree level. Similarly, in image processing or streaming applications where the same blocks are accessed in an interleaved manner, the algorithm's consideration of historical access patterns helps maintain frequently used data in the cache.

The implementation includes specific mechanisms for bit updates. Current access bits are updated along the path from root to accessed block, while previous access bits are shifted from current bits during updates. Only nodes along the access path are modified, preserving historical information in other branches of the tree. During the replacement selection process, tree traversal uses previous access bits at non-leaf levels, while current access bits are used only at the leaf level. Each non-leaf level's previous access bit determines the branch selection for traversal.

The hardware implementation of this algorithm is designed for practical deployment in cache systems. The algorithm functions effectively for caches up to 32 entries, requiring n−1 previous access bits for an n-way cache. The update logic complexity remains manageable due to the selective update approach where only nodes along the access path require modification. This selective update mechanism helps balance the trade-off between maintaining historical information and implementation overhead.

In multi-threaded environments, the algorithm adapts well to scenarios where different threads operate on distinct regions of memory. As threads alternate their cache access patterns, the previous access bits help maintain a more accurate picture of block usage over time, leading to more effective replacement decisions. This capability becomes particularly relevant in modern processing systems where multiple threads frequently compete for cache resources.

In some implementations, the cache controller implements the replacement policy by maintaining both sets of bits—previous and current—at each non-leaf node, while performing updates selectively to maintain historical access patterns. When a cache miss occurs, the replacement block selection begins at the root node of the binary tree. The controller uses the previous access bit at each non-leaf level to determine which branch to traverse, selecting the path that leads to the least recently used region of the cache.

During cache accesses, the bit update mechanism operates on nodes along the path from root to the accessed block. For example, in an 8-way configuration accessing block B5, the controller updates the bits along the specific path through nodes containing the accessed block's information. The remaining nodes retain their existing values, preserving access history for other cache regions. This selective update approach maintains historical context while reducing unnecessary bit modifications.

The binary tree structure scales naturally with cache size while maintaining consistent access and update operations. For a 4-way cache, the tree requires three nodes with previous and current bits. An 8-way cache expands this to seven nodes, and a 16-way cache would use fifteen nodes. The relationship between cache associativity and required nodes follows a pattern where an n-way cache requires 2n−1 nodes total.

In practice, the algorithm demonstrates particular effectiveness when memory access patterns exhibit locality within regions but periodically switch between different regions. This occurs commonly in graphics processing workloads where different threads may operate on separate data regions, or in streaming applications where data access alternates between different buffers or memory areas.

The cache replacement decisions benefit from the historical context when access patterns return to previously used cache regions. By considering both current and previous access states, the algorithm can better predict which blocks might be needed again soon, potentially reducing unnecessary evictions and subsequent cache misses.

The performance characteristics of the history-based PLRU algorithm become apparent in several common access scenarios. When a processor executes instructions that alternate between different memory regions, the algorithm's use of previous access bits helps maintain more accurate tracking of block usage patterns. This tracking mechanism becomes particularly relevant when different threads or processes share cache resources, each operating primarily within its own memory region.

A typical implementation example involves translation lookaside buffer (TLB) caches, where access patterns often show strong temporal locality within regions but periodically switch between different address spaces. The history-based approach adapts well to these patterns by preserving information about previous accesses even as the current access pattern shifts to a different region.

The hardware implementation requires additional storage for the previous access bits, but this overhead remains bounded by the cache associativity. In a 4-way set associative cache, the traditional PLRU requires three bits per set, while the history-based approach requires six bits-three for current access bits and three for previous access bits. For an 8-way cache, the requirement increases to fourteen bits per set-seven each for current and previous access states.

The implementation manages bit updates through standard digital logic components. The update process involves shifting the current access bit to become the previous access bit, then setting the new current access bit based on the cache access. This shift-and-update operation occurs only for nodes along the path to the accessed block, limiting the amount of logic that activates during each cache access.

For detecting whether the algorithm is functioning correctly, a predetermined sequence of memory accesses can be used to verify the replacement decisions. The sequence should include patterns that alternate between different cache regions to demonstrate the algorithm's ability to track historical usage. The resulting cache contents and replacement decisions can be compared against expected outcomes based on the history-based PLRU policy.

The performance characteristics of the history-based PLRU algorithm become apparent in several common access scenarios. When a processor executes instructions that alternate between different memory regions, the algorithm's use of previous access bits helps maintain more accurate tracking of block usage patterns. This tracking mechanism becomes particularly relevant when different threads or processes share cache resources, each operating primarily within its own memory region.

The hardware implementation requires additional storage for the previous access bits, but this overhead remains bounded by the cache associativity. In a 4-way set associative cache, the traditional PLRU requires three bits per set, while the history-based approach requires six bits-three for current access bits and three for previous access bits. For an 8-way cache, the requirement increases to fourteen bits per set-seven each for current and previous access states.

The implementation manages bit updates through standard digital logic components. The update process involves shifting the current access bit to become the previous access bit, then setting the new current access bit based on the cache access. This shift-and-update operation occurs only for nodes along the path to the accessed block, limiting the amount of logic that activates during each cache access.

The history-based PLRU algorithm shows particular benefits in scenarios where memory accesses exhibit “ping ponging” behavior between different sections of the cache. This behavior commonly occurs when each thread or process gets mapped to a certain section of the cache, leading to series of accesses to one particular section of the cache followed by accesses to another section. By maintaining historical access information, the algorithm can make more appropriate replacement decisions during these section transitions compared to traditional PLRU approaches that only consider the most recent access.

The algorithm is specifically designed and optimized for cache structures with up to 32 entries. This size constraint helps maintain practical hardware implementation while providing benefits for the common cache configurations found in modern processing systems.

The history-based Pseudo Least Recently Used algorithm represents an advancement in cache replacement strategies by combining the binary tree structure of PLRU methods with historical access information. This combination enables more accurate replacement decisions while maintaining hardware feasibility. The algorithm's binary tree structure scales naturally from 4-way through 32-way cache configurations, with the addition of previous access bits at non-leaf nodes providing enhanced tracking of access patterns.

The algorithm demonstrates particular effectiveness in modern processing environments where memory accesses frequently alternate between different cache regions, such as in multi-threaded workloads or streaming applications. By considering both current and historical access patterns, the approach provides more accurate identification of least recently used blocks compared to traditional PLRU algorithms, while maintaining practical hardware implementation requirements.

The selective update mechanism, where only nodes along the access path require modification, helps balance the trade-off between maintaining historical information and implementation overhead. This approach enables the algorithm to track access patterns effectively while keeping hardware requirements manageable for practical cache implementations.

An implementation is a method for cache replacement may include storing a previous access bit and a current access bit for each upper level of a binary tree representing cache blocks, accessing, by a processor, a data segment in memory, selecting, by a cache controller in response to a cache miss for the data segment, a cache block for replacement using the binary tree by traversing the binary tree using the previous access bit at a first upper level, and using the current access bit at a lowest level to determine the cache block for replacement.

The described implementations may also include one or more of the following features. The method where the binary tree may include multiple levels corresponding to different cache associativities. The method where a root node of the binary tree represents an entire cache set, and leaf nodes represent individual cache blocks. The method may further include updating the current access bit for a node in the binary tree when a corresponding cache block or set is accessed. The method may further include shifting the current access bit to become the previous access bit when updating the current access bit. The method where traversing the binary tree may include: iteratively descending the binary tree by selecting one of two child nodes at each upper level based on the previous access bit, where the two child nodes represent distinct subsets of cache blocks. The method where using the previous access bit at the first upper level may include selecting a branch that was least recently accessed during traversal.

An implementation is a system for cache replacement may include one or more processors, a cache memory coupled to the one or more processors, and a cache controller. The cache controller may be configured to maintain a binary tree representing cache blocks, where each non-leaf node of the binary tree includes a previous access bit and a current access bit, access a data segment in memory, and select, in response to a cache miss for the data segment, a cache block for replacement using the binary tree by traversing the binary tree using the previous access bit at each non-leaf node and the current access bit at a leaf node.

The described implementations may also include one or more of the following features. The system where the cache controller is further configured to update the current access bit for a node in the binary tree when a corresponding cache block or set is accessed. The system where the cache controller is further configured to shift the current access bit to become the previous access bit when updating the current access bit. The system where the binary tree may include multiple levels corresponding to different cache associativities. The system where a root node of the binary tree represents an entire cache set, and leaf nodes represent individual cache blocks. The system where traversing the binary tree may include: iteratively descending the binary tree by selecting one of two child nodes at each non-leaf level based on the previous access bit, where the two child nodes represent distinct subsets of cache blocks. The system where using the previous access bit at each non-leaf node may include selecting a branch that was least recently accessed during traversal.

An implementation is a non-transitory computer-readable storage medium storing instructions that, when executed by one or more processors, cause the one or more processors to perform a cache replacement method, the method may include maintaining a binary tree representing cache blocks, where each non-leaf node of the binary tree includes a previous access bit and a current access bit, receiving a request to access a data segment, selecting, in response to a cache miss for the data segment, a cache block for replacement using the binary tree by traversing the binary tree using the previous access bit at each non-leaf node and the current access bit at a leaf node.

The described implementations may also include one or more of the following features. The non-transitory computer-readable storage medium where the method further may include updating the current access bit for a node in the binary tree when a corresponding cache block or set is accessed. The non-transitory computer-readable storage medium where the method further may include shifting the current access bit to become the previous access bit when updating the current access bit. The non-transitory computer-readable storage medium where the binary tree may include multiple levels corresponding to different cache associativities. The non-transitory computer-readable storage medium where a root node of the binary tree represents an entire cache set, and leaf nodes represent individual cache blocks. The non-transitory computer-readable storage medium where using the previous access bit at each non-leaf node may include selecting a branch that was least recently accessed during traversal.

Although the description has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular implementations described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding implementations described herein. Accordingly, the appended claims are intended to include within their scope such processes, machines, manufacture, compositions of matter, means, methods, or steps.

What is claimed is:

1. A method for cache replacement, comprising:
storing a previous access bit and a current access bit for each upper level of a binary tree representing cache blocks;
accessing, by a processor, a data segment in memory; and
selecting, by a cache controller in response to a cache miss for the data segment, a cache block for replacement using the binary tree by traversing the binary tree using the previous access bit at a first upper level, and using the current access bit at a lowest level to determine the cache block for replacement.

2. The method of claim 1, wherein the binary tree comprises multiple levels corresponding to different cache associativities.

3. The method of claim 2, wherein a root node of the binary tree represents an entire cache set, and leaf nodes represent individual cache blocks.

4. The method of claim 1, further comprising:
updating the current access bit for a node in the binary tree when a corresponding cache block or set is accessed.

5. The method of claim 4, further comprising:
shifting the current access bit to become the previous access bit when updating the current access bit.

6. The method of claim 1, wherein traversing the binary tree comprises:
iteratively descending the binary tree by selecting one of two child nodes at each upper level based on the previous access bit, wherein the two child nodes represent distinct subsets of cache blocks.

7. The method of claim 1, wherein using the previous access bit at the first upper level comprises selecting a branch that was least recently accessed during traversal.

8. A system for cache replacement, comprising:
one or more processors;
a cache memory coupled to the one or more processors; and
a cache controller configured to:
maintain a binary tree representing cache blocks, wherein each non-leaf node of the binary tree includes a previous access bit and a current access bit;
access a data segment in memory; and
select, in response to a cache miss for the data segment, a cache block for replacement using the binary tree by traversing the binary tree using the previous access bit at each non-leaf node and the current access bit at a leaf node.

9. The system of claim 8, wherein the cache controller is further configured to update the current access bit for a node in the binary tree when a corresponding cache block or set is accessed.

10. The system of claim 9, wherein the cache controller is further configured to shift the current access bit to become the previous access bit when updating the current access bit.

11. The system of claim 8, wherein the binary tree comprises multiple levels corresponding to different cache associativities.

12. The system of claim 11, wherein a root node of the binary tree represents an entire cache set, and leaf nodes represent individual cache blocks.

13. The system of claim 8, wherein traversing the binary tree comprises:
iteratively descending the binary tree by selecting one of two child nodes at each non-leaf level based on the previous access bit, wherein the two child nodes represent distinct subsets of cache blocks.

14. The system of claim 8, wherein using the previous access bit at each non-leaf node comprises selecting a branch that was least recently accessed during traversal.

15. A non-transitory computer-readable storage medium storing instructions that, when executed by one or more processors, cause the one or more processors to perform a cache replacement method, the method comprising:
maintaining a binary tree representing cache blocks, wherein each non-leaf node of the binary tree includes a previous access bit and a current access bit;
receiving a request to access a data segment; and
selecting, in response to a cache miss for the data segment, a cache block for replacement using the binary tree by traversing the binary tree using the previous access bit at each non-leaf node and the current access bit at a leaf node.

16. The non-transitory computer-readable storage medium of claim 15, wherein the method further comprises:
updating the current access bit for a node in the binary tree when a corresponding cache block or set is accessed.

17. The non-transitory computer-readable storage medium of claim 16, wherein the method further comprises:
shifting the current access bit to become the previous access bit when updating the current access bit.

18. The non-transitory computer-readable storage medium of claim 15, wherein the binary tree comprises multiple levels corresponding to different cache associativities.

19. The non-transitory computer-readable storage medium of claim 18, wherein a root node of the binary tree represents an entire cache set, and leaf nodes represent individual cache blocks.

20. The non-transitory computer-readable storage medium of claim 15, wherein using the previous access bit at each non-leaf node comprises selecting a branch that was least recently accessed during traversal.
